(19) United States
(12) Patent Application Publication
(10) Pub. No.: US 2021/0048697 A1
(43) Pub. Date: Feb. 18, 2021

(54) VIEW ANGLE CONTROL STRUCTURE AND DISPLAY APPARATUS

(71) Applicant: Coretronic Corporation, Hsin-Chu (TW)

(72) Inventors: Ping-Yen Chen, Hsin-Chu (TW); Chung-Yang Fang, Hsin-Chu (TW); Wen-Chun Wang, Hsin-Chu (TW)

(73) Assignee: Coretronic Corporation, Hsin-Chu (TW)

(21) Appl. No.: 16/986,275

(22) Filed: Aug. 6, 2020

(30) Foreign Application Priority Data
Aug. 16, 2019 (CN) 201910757002.8

(51) Int. Cl. G02F 1/13; G02F 1/1335; G02F 1/1337

(52) U.S. Cl. CPC G02F 1/1323; G02F 1/1337; G02F 1/133528

(57) ABSTRACT

A view angle control structure and a display apparatus are provided. The display apparatus at least includes the view angle control structure, which includes first and second polarizing layers, first and second substrates and a polarization adjusting layer. The first and second polarizing layers are sequentially disposed on a transmission path of a light beam. The first and second substrates are sequentially disposed on the transmission path of the light beam and located between the first and second polarizing layers. At least one of the first and second substrates has a birefringence. The polarization adjusting layer is disposed on the transmission path of the light beam and located between the first and second substrates for changing a polarization state of the light beam according to an applied voltage. The view angle control structure and the display apparatus of the invention are excellent in anti-peeping effect, slimness and image quality.

### CROSS-REFERENCE TO RELATED APPLICATION

This application claims the priority benefit of China application serial no. 201910757002.8, filed on Aug. 16, 2019. The entirety of the above-mentioned patent application is hereby incorporated by reference herein and made a part of this specification.

### BACKGROUND

### Technical Field

The invention relates to a display apparatus, and more particularly, to a view angle control structure and a display apparatus with an anti-peeping function.

### Description of Related Art

Along with the development of technologies, display apparatuses have already been popularized in users' daily life. In recent years, the users started to pay attention to the privacy issue, and hoped to prevent others from peeping important or privacy information while viewing the screen. Currently, some display apparatuses are already provided with an anti-peeping function to protect the users' privacy. However, most anti-peeping display apparatuses on the market have a poor anti-peeping effect, an insufficient image contrast or an excessively thick anti-peeping protector. Especially, when being applied to light and thin or flexible display apparatuses, existing anti-peeping structures (film or device) are often too thick or too difficult to attach and are thus not accepted by the market. Therefore, all the manufacturers in the industry are expecting to provide an anti-peeping display apparatus which is good in anti-peeping effect, light and thin and good in display quality.

The information disclosed in this Background section is only for enhancement of understanding of the background of the described technology and therefore it may contain information that does not form the prior art that is already known to a person of ordinary skill in the art. Further, the information disclosed in the Background section does not mean that one or more problems to be resolved by one or more embodiments of the invention was acknowledged by a person of ordinary skill in the art.

### SUMMARY

Embodiments of the invention provide a view angle control structure and a display apparatus, which have the advantages of being excellent in anti-peeping effect, light and thin, flexible and good in image quality.

Other objectives and advantages of the invention may be further known from the technical features disclosed by the invention.

In order to achieve one or part or all of the above-mentioned objectives or other objectives, an embodiment of the invention provides a view angle control structure. The view angle control structure includes a first polarizing layer, a second polarizing layer, a first substrate, a second substrate and a polarization adjusting layer. The first polarizing layer and the second polarizing layer are sequentially disposed on a transmission path of a light beam. The first substrate and the second substrate are sequentially disposed on the transmission path of the light beam and are located between the first polarizing layer and the second polarizing layer, wherein at least one of the first substrate and the second substrate has a birefringence. The polarization adjusting layer is disposed on the transmission path of the light beam and located between the first substrate and the second substrate and is configured to change a polarization state of the light beam according to an applied voltage.

In order to achieve one or part or all of the above-mentioned objectives or other objectives, an embodiment of the invention provides a display apparatus, including a light emitting module, a view angle control structure and a display panel. The light emitting module is configured to provide an illuminating light beam. The view angle control structure is disposed on the light emitting module, and includes a first polarizing layer, a second polarizing layer, a first substrate, a second substrate and a first polarization adjusting layer. The first polarizing layer and the second polarizing layer are sequentially disposed on a transmission path of the illuminating light beam. The first substrate and the second substrate are sequentially disposed on the transmission path of the illuminating light beam and are located between the first polarizing layer and the second polarizing layer, wherein at least one of the first substrate and the second substrate has a birefringence. The polarization adjusting layer is disposed on the transmission path of the illuminating light beam and located between the first substrate and the second substrate. The display panel is disposed on the view angle control structure and is configured to convert an illuminating light beam coming from the view angle control structure into a display light beam. The first polarization adjusting layer is configured to change a polarization state of the illuminating light beam according to a first applied voltage.

In order to achieve one or part or all of the above-mentioned objectives or other objectives, an embodiment of the invention provides a display apparatus, including a view angle control structure and a display panel. The display panel is configured to provide a display light beam. The view angle control structure is disposed on the display panel, and includes a first polarizing layer, a second polarizing layer, a first substrate, a second substrate and a second polarization adjusting layer. The first polarizing layer and the second polarizing layer are sequentially disposed on a transmission path of the display light beam. The first substrate and the second substrate are sequentially disposed on a transmission path of the display light beam and are located between the first polarizing layer and the second polarizing layer, wherein at least one of the first substrate and the second substrate has a birefringence. The first polarization adjusting layer is disposed on the transmission path of the display light beam and located between the first substrate and the second substrate. The first polarization adjusting layer is configured to change a polarization state of the display light beam according to a first applied voltage.

Based on the above, the view angle control structure and the display apparatus of the embodiments of the invention can be switched between a normal mode and an anti-peeping mode, and with the materials selected for the first substrate and the second substrate, both the volume and the weight of the view angle control structure can be reduced. Therefore, the display apparatus of the embodiments of the invention has the advantages of being excellent in anti-peeping effect, light and thin and good in display quality.

Other objectives, features and advantages of the invention will be further understood from the further technological features disclosed by the embodiments of the invention wherein there are shown and described preferred embodiments of this invention, simply by way of illustration of modes best suited to carry out the invention.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1A is a schematic block diagram of a display apparatus according to an embodiment of the invention.

FIG. 1B is a schematic diagram of a view angle control structure according to an embodiment of the invention.

FIG. 2A to FIG. 2D are respectively light emitting pattern distribution diagrams of different view angle control structures according to an embodiment of the invention.

FIG. 3 is a schematic structural diagram of a display apparatus according to an embodiment of the invention.

FIG. 4 is a schematic structural diagram of a display apparatus according to another embodiment of the invention.

FIG. 5 is a schematic structural diagram of a display apparatus according to another embodiment of the invention.

FIG. 6 is a schematic structural diagram of a display apparatus according to another embodiment of the invention.

FIG. 7 is a schematic structural diagram of a display apparatus according to another embodiment of the invention.

FIG. 8 is a schematic structural diagram of a display apparatus according to another embodiment of the invention.

### DESCRIPTION OF THE EMBODIMENTS

In the following detailed description of the preferred embodiments, reference is made to the accompanying drawings which form a part hereof, and in which are shown by way of illustration specific embodiments in which the invention may be practiced. In this regard, directional terminology, such as “top,” “bottom,” “front,” “back,” etc., is used with reference to the orientation of the Figure(s) being described. The components of the invention can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings. Similarly, the terms “facing,” “faces” and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component directly faces “B” component or one or more additional components are between “A” component and “B” component. Also, the description of “A” component “adjacent to” “B” component herein may contain the situations that “A” component is directly “adjacent to” “B” component or one or more additional components are between “A” component and “B” component. Accordingly, the drawings and descriptions will be regarded as illustrative in nature and not as restrictive.

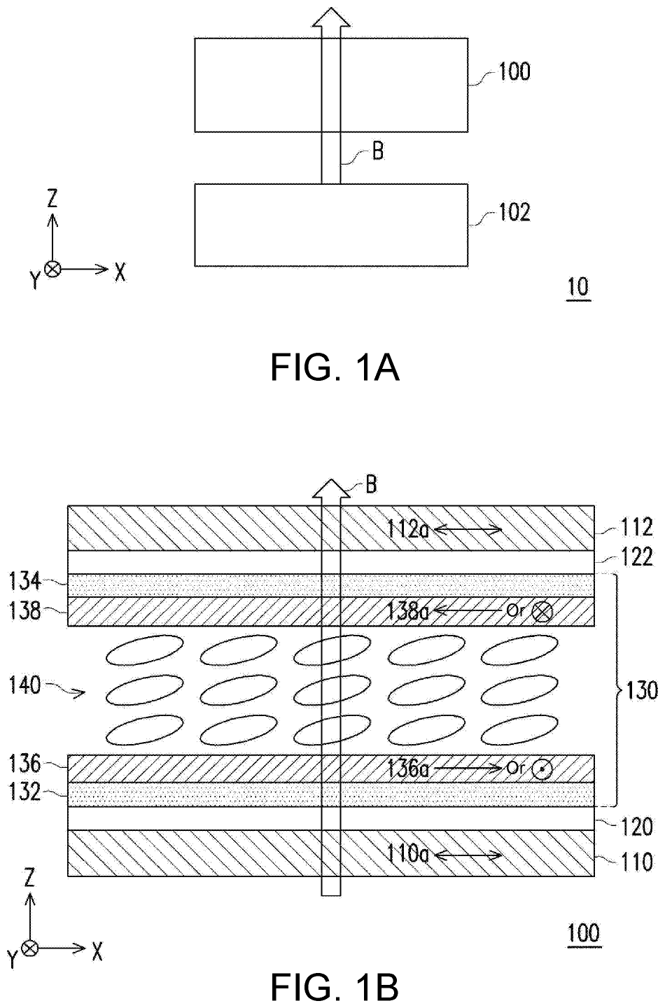

FIG. 1A is a schematic block diagram of a display apparatus according to an embodiment of the invention. FIG. 1B is a schematic diagram of a view angle control structure according to an embodiment of the invention. Referring to FIG. 1A first, a display apparatus 10 at least includes a view angle control structure 100 and a display or light emitting module 102. The display or light emitting module 102 is configured to provide a light beam B, wherein the light beam B may be an illuminating light beam emitted by the light emitting module or a display light beam emitted by the display module. The view angle control structure 100 is disposed on a transmission path of the light beam B, and configured to adjust a view angle range of the light beam B so that the display apparatus 10 can provide at least two light emitting modes with different view angle ranges, for example, a normal mode with a wide view angle range and an anti-peeping mode with a narrow view angle.

Referring to FIG. 1B, the specific structure of the view angle control structure 100 of FIG. 1A may be illustrated with the structure of FIG. 1B. The view angle control structure 100 includes a first polarizing layer 110, a second polarizing layer 112, a first substrate 120, a second substrate 122 and a polarization adjusting layer 130. The first polarizing layer 110 and the second polarizing layer 112 are sequentially disposed on a transmission path of the light beam B. The first substrate 120 and the second substrate 122 are sequentially disposed on the transmission path of the light beam B and are located between the first polarizing layer 110 and the second polarizing layer 112, wherein at least one of the first substrate 120 and the second substrate 122 has a birefringence. The polarization adjusting layer 130 is disposed on the transmission path of the light beam B and located between the first substrate 120 and the second substrate 122 and is configured to adjust a polarization state of the light beam B according to an applied voltage. A light emitting view angle range of the light beam B after leaving the second polarizing layer 112 is changed by adjusting the polarization state of the light beam B between the first polarizing layer 110 and the second polarizing layer 112, so that the display apparatus 10 can be switched between the anti-peeping mode and the normal mode.

It should be particularly noted that, in the embodiment, the first substrate 120 and the second substrate 122 are made from a polymer film material, for example, polyimide (PI), triacetyl cellulose (TAC), cyclo olefin polymer (COP), polycarbonate (PC), and the like. One of the first substrate 120 and the second substrate 122 may be made from a material with a birefringence, or both of the two may have a birefringence, and their optical axis types may have different implementations such as A-plate, C-plate, O-plate or Biaxial. Further, a sum of out-of-plane retardations (Rth) of the first substrate 120 and the second substrate 122 preferably falls within a range of 200 nanometers to 800 nanometers (nm), and more preferably falls within a range of 200 nanometers to 600 nanometers. Moreover, if optical axis directions of the first substrate 120 and the second substrate 122 are not perpendicular or parallel to a direction of an absorption axis of the corresponding polarizing layer (the closer one of the first polarizing layer 110 or the second polarizing layer 112), in-plane retardations (RO) of the first substrate 120 and the second substrate 122 both need to be less than or equal to 150 nanometers (nm). By virtue of the out-of-plane retardations provided by the first substrate 120 and the second substrate 122, the configuration of a conventional compensation film may be omitted for the display apparatus 10, thereby simplifying the structure.

Because the first substrate 120 and the second substrate 122 are made from a polymer film material, the view angle control structure 100 has the advantages of being relatively light in weight and relatively small in thickness compared with an existing anti-peeping plate using a glass substrate, and the substrate (either the first substrate 120 or the second substrate 122) can be well attached to the polarizing layer (either the first polarizing layer 110 or the second polarizing layer 112), and peeling which may cause deformation or warping does not easily occur between the two. Moreover, with the advantage of small thickness, the view angle control structure 100 can be directly attached to a display panel, and a white sealant may be used for packaging in the packaging process, so as to suppress the problem of light leakage at edges of the display apparatus. In an embodiment, the first substrate 120 or the second substrate 122 may be made from a flexible material (for example, a PI film) to make the view angle control structure 100 flexible. When the display apparatus 10 is a foldable or flexible display apparatus, the flexible view angle control structure 100 can maintain the characteristic of the foldable or display apparatus, thereby further expanding the application range of the view angle control structure 100.

Implementation details of the polarization adjusting layer 130 and embodiments of a plurality of display apparatuses will be further described below.

The polarization adjusting layer 130 includes a first electrode 132, a second electrode 134, a first alignment layer 136, a second alignment layer 138 and a liquid crystal layer 140. The first electrode 132 and the second electrode 134 are respectively disposed at two opposite sides of the liquid crystal layer 140 and are configured to provide the applied voltage to the liquid crystal layer 140. The first alignment layer 136 is located between the first electrode 132 and the liquid crystal layer 140, the second alignment layer 138 is located between the liquid crystal layer 140 and the second electrode 134, and a first alignment direction 136a of the first alignment layer 136 and a second alignment direction 138a of the second alignment layer 138 are configured to be parallel opposite directions (i.e., antiparallel) or approximately parallel opposite directions. More specifically, an included angle between the first alignment direction 136a and the second alignment direction 138a falls within a range of 165 degrees to 195 degrees. Besides, a direction of an absorption axis 110a of the first polarizing layer 110 is configured to be parallel to, approximately parallel to, perpendicular to, or approximately perpendicular to the first alignment direction 136a. A direction of an absorption axis 112a of the second polarizing layer 112 and the second alignment direction 138a are configured in a similar way. In other words, an included angle between the first alignment direction 136a of the first alignment layer 136 and the direction of the absorption axis 110a of the first polarizing layer 110 falls within a range of −15 degrees to 15 degrees or a range of 75 degrees to 105 degrees, and an included angle between the second alignment direction 138a of the second alignment layer 138 and the direction of the absorption axis 112a of the second polarizing layer 112 also falls within the range of −15 degrees to 15 degrees or a range of 75 degrees to 105 degrees.

Because arrangement directions of liquid crystal molecules of the liquid crystal layer 140 are changed by the applied voltage between the first electrode 132 and the second electrode 134, the polarization state of the light beam B is changed, influencing a light emitting pattern (i.e., lighting pattern or light distribution) of the light beam B after leaving the display apparatus 10. In the embodiment, when the applied voltage equals to 0 Volt (i.e., the liquid crystal molecules are arranged in a normal distribution) or a high voltage is applied to cause most liquid crystal molecules of the liquid crystal layer 140 to stand approximately vertically, the light emitting pattern of the light beam B after passing through the view angle control structure 100 has a wide view angle range, and in this case, the display apparatus 10 is in the normal mode. When the applied voltage is between 0 V and the high voltage and causes the liquid crystal molecules to tilt, the light emitting pattern of the light beam B after passing through the view angle control structure 100 is changed. That is, a light emitting intensity at a front view angle (for example, Z direction) is nearly not influenced by the liquid crystal molecules, and a light emitting intensity at a side view angle (for example, a view angle of 60 degrees from the left side of the display apparatus 10 and a view angle of 60 degrees from the right side of the display apparatus 10) is greatly reduced, so that the view angle range is reduced. In this case, a viewer viewing at the front view angle may still enjoy good image display quality, and other people viewing at the side view angle cannot clearly see the screen of the display apparatus 10. In this case, the display apparatus 10 is in the anti-peeping mode, the display apparatus 10 can protect privacy.

It is to be noted that, an optical phase difference of the liquid crystal layer 140 in the embodiment falls within a range of 600 nanometers to 1000 nanometers, which is different from an optical phase difference of a liquid crystal layer in a known liquid crystal display panel.

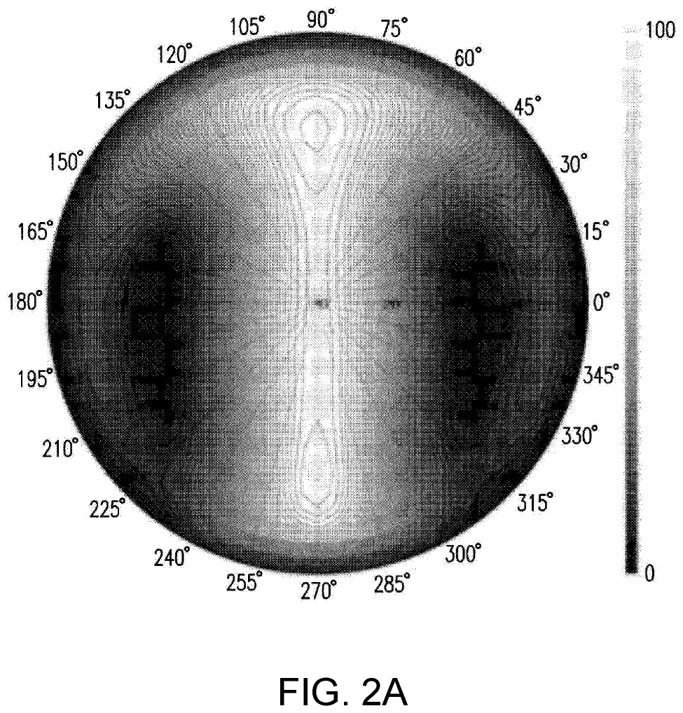

FIG. 2A to FIG. 2D are respectively light emitting pattern distribution diagrams of different view angle control structures according to an embodiment of the invention, where brightness degrees in the distribution diagrams represent light emitting intensity. FIG. 2A to FIG. 2D respectively show light emitting pattern distributions of a fixed light source after passing through different view angle control structures 100 in the anti-peeping mode.

Referring to FIG. 1B and FIG. 2A together, in the embodiment of FIG. 2A, the first substrate 120 and the second substrate 122 are both made from a biaxial material with a birefringence, for example, TAC or COP. The in-plane retardations RO of the first substrate 120 and the second substrate 122 are both 150 nm, and the out-of-plane retardations Rth are both 140 nm. The sum of the out-of-plane retardations Rth of the first substrate 120 and the second substrate 122 falls within a range of 200 nm to 800 nm.

The first alignment direction 136a of the first alignment layer 136 and the second alignment direction 138a of the second alignment layer 138 are respectively 85 degrees and 275 degrees relative to an X axis, and the included angle therebetween falls within a range of 165 degrees to 195 degrees. In other words, an acute included angle between the first alignment direction 136a of the first alignment layer 136 and the second alignment direction 138a of the second alignment layer 138 is less than 15 degrees. The directions of the absorption axes of the first polarizing layer 110 and the second polarizing layer 112 are respectively −5 degrees and 5 degrees relative to the X axis. The first alignment direction 136a of the first alignment layer 136 is perpendicular to the direction of the absorption axis of the first polarizing layer 110 and the second alignment direction 138a of the second alignment layer 138 is also perpendicular to the direction of the absorption axis of the second polarizing layer 112.

Referring to FIG. 1B and FIG. 2B together, in the embodiment of FIG. 2B, one of the first substrate 120 and the second substrate 122 is made from a material with a birefringence. For example, the first substrate 120 is made from a material with an isotropic refractive index (for example, TAC), and does not cause a phase change of the light beam B. The second substrate 122 is made from a material with a birefringence (for example, a PI film), and has a C-plate structure. The out-of-plane retardation Rth of the second substrate 122 is 450 nm. Therefore, the sum of the out-of-plane retardations Rth of the first substrate 120 and the second substrate 122 still falls within the range of 200 nm to 800 nm.

The first alignment direction 136a of the first alignment layer 136 and the second alignment direction 138a of the second alignment layer 138 are respectively 80 degrees and 270 degrees relative to the X axis, and the included angle therebetween falls within the range of 165 degrees to 195 degrees, that is, the acute included angle is less than 15 degrees. The directions of the absorption axes of the first polarizing layer 110 and the second polarizing layer 112 are respectively 0 degrees and −10 degrees relative to the X axis. The alignment direction of the first alignment layer 136 is not perpendicular, but approximately perpendicular, to the direction of the absorption axis of the first polarizing layer 110. The alignment direction of the second alignment layer 138 is also approximately perpendicular to the direction of the absorption axis of the second polarizing layer 112.

However, the invention is not limited to the above. In another embodiment, the directions of the absorption axes of the first polarizing layer 110 and the second polarizing layer 112 and the alignment directions of the first alignment layer 136 and the second alignment layer 138 are the same as those in the embodiment of FIG. 2B, but the first substrate 120 and the second substrate 122 are both made from a material with a birefringence and both have the C-plate structure. The out-of-plane retardations Rth of the first substrate 120 and the second substrate 122 may be both selected as 225 nm or both selected as 150 nm.

Referring to FIG. 1B and FIG. 2C together, in the embodiment of FIG. 2C, the first substrate 120 is made from a material with an isotropic refractive index, and the second substrate 122 is made from a material with a birefringence having a double A-plate structure, wherein optical axis directions of the upper layer and the lower layer, for example, are respectively 45 degrees and 135 degrees. The directions of absorption axes of the first polarizing layer 110 and the second polarizing layer 112 are both 90 degrees relative to the X axis, and are parallel to each other. In the embodiment, the sum of the out-of-plane retardation Rth of the second substrate 122 is 450 nm. The sum of the out-of-plane retardations Rth of the first substrate 120 and the second substrate 122 falls within a range of 200 nm to 800 nm.

The alignment directions of the first alignment layer 136 and the second alignment layer 138 are respectively 90 degrees and 270 degrees relative to the X axis. The alignment directions of the first alignment layer 136 and the second alignment layer 138 are opposite to each other. The alignment direction of the first alignment layer 136 is parallel to the direction of the absorption axis of the first polarizing layer 110 and the alignment direction of the second alignment layer 138 is parallel to the direction of the absorption axis of the second polarizing layer 112.

Referring to FIG. 1B and FIG. 2D together, in the embodiment of FIG. 2D, the first substrate 120 and the second substrate 122 are both made from a material with a birefringence. The first substrate 120 is made from a biaxial material. The second substrate 122 has a C-plate structure. The out-of-plane retardation Rth of the first substrate 122 is 140 nm, and the out-of-plane retardation Rth of the second substrate 122 is 150 nm. Therefore, the sum of the out-of-plane retardations Rth of the first substrate 120 and the second substrate 122 still falls within the range of 200 nm to 800 nm.

The alignment directions of the first alignment layer 136 and the second alignment layer 138 are respectively 90 degrees and 270 degrees relative to the X axis, and the included angle therebetween falls within a range of 165 degrees to 195 degrees. The directions of absorption axes of the first polarizing layer 110 and the second polarizing layer 112 are both 0 degree relative to the X axis. The alignment direction of the first alignment layer 136 is perpendicular to the direction of the absorption axis of the first polarizing layer 110. The alignment direction of the second alignment layer 138 is also perpendicular to the direction of the absorption axis of the second polarizing layer 112.

It may be known from results of the light emitting pattern distribution diagrams of different embodiments of FIG. 2A to FIG. 2D that, when the applied voltage is provided to the polarization adjusting layer 130, the view angle control structure 100 has high transmittance in a forward direction (for example, 0 degree) directly facing the view angle control structure 100, but light emission in left and right lateral directions (for example, the view angle range close to −45 degrees and 45 degrees) is restrained. Therefore, the view angle control structure 100 has a narrow view angle range, and can provide a good anti-peeping effect.

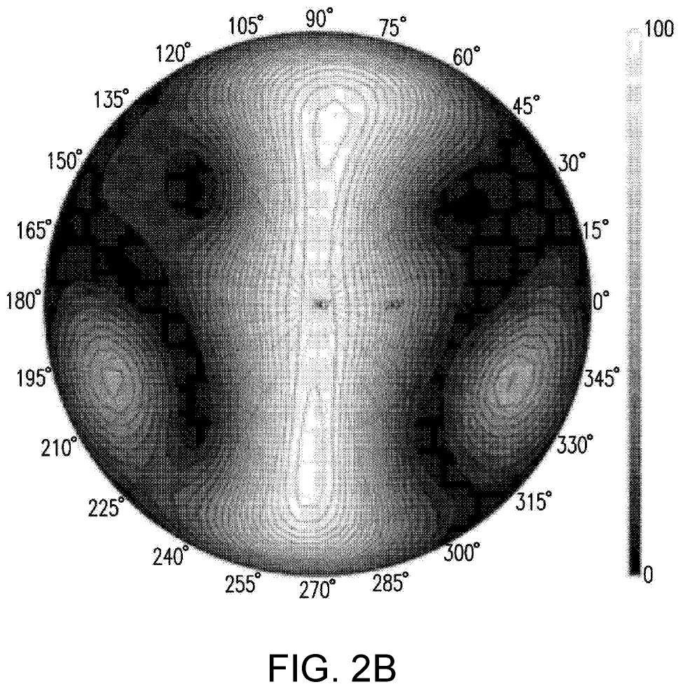

FIG. 3 is a schematic structural diagram of a display apparatus according to the invention. Referring to FIG. 3, a display apparatus 30 includes a light emitting module 200, a view angle control structure 100 and a display panel 300. The light emitting module 200 is configured to provide an illuminating light beam LB. The view angle control structure 100 is disposed on the light emitting module 200, and the specific structure and implementation are as described in the embodiment of FIG. 2. The light beam B in FIG. 2 is the illuminating light beam LB in the embodiment. The display panel 300 is disposed on the view angle control structure 100, and is configured to convert the illuminating light beam LB coming from the view angle control structure 100 into a display light beam IB.

The display panel 300 at least includes a third polarizing layer 310 and a liquid crystal display layer 320. The third polarizing layer 310 is disposed on a transmission path of the display light beam IB, and the liquid crystal display layer 320 is disposed between the second polarizing layer 112 and the third polarizing layer 310. In the embodiment, the display panel 300 may further include a polarizing layer 330 disposed between the second polarizing layer 112 and the liquid crystal display layer 320. However, in other embodiments, in order to simplify the structure, the display panel 300 may omit the polarizing layer 330 and share the second polarizing layer 112 with the view angle control structure 100.

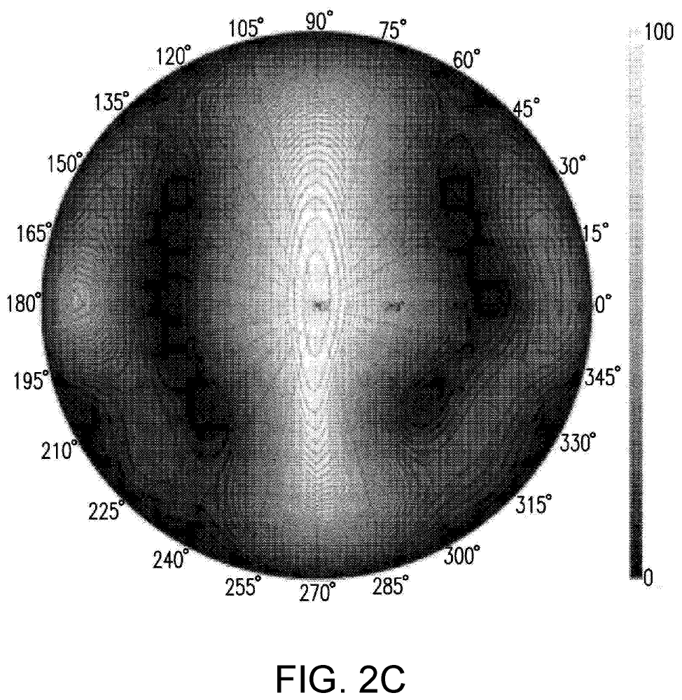

FIG. 4 is a schematic structural diagram of a display apparatus according to another embodiment of the invention. Referring to FIG. 4, a structure of a display apparatus 40 is substantially similar to that of the display apparatus 30, but the display apparatus 40 additionally includes a light control film (LCF) 410. The light control film 410 is capable of adjusting a direction of transmitted light (for example, a light emitting range of transmitted light). The light control film 410 may be disposed on the transmission path of the illuminating light beam LB or the display light beam IB, which is not limited in the invention. In the embodiment of FIG. 4, the light control film 410 is disposed between the light emitting module 200 and the view angle control structure 100. The illuminating light beam LB passes through the light control film 410 first and then passes through the view angle control structure 100, and finally becomes the display light beam IB and leaves the display panel 300. However, in other embodiments, the light control film 410 may be disposed above (for example, Z direction in the drawing) the display panel 300, that is, on the transmission path of the display light beam IB. The illuminating light beam LB passes through the view angle control structure 100 and the display panel 300 first to be converted into the display light beam IB and then passes through the light control film 410.

The view angle range of the light control film 410 may be greater than the view angle range of the view angle control structure 100 in the anti-peeping mode, and a display mode of the display apparatus 40 is still mainly determined by the applied voltage of the view angle control structure 100. For example, the view angle range of the view angle control structure 100 in the anti-peeping mode may be only between positive and negative 45 degrees, while the view angle range of the light control film 410 may be between positive and negative 60 degrees, which are not limited in the invention. In the anti-peeping mode, the light emitting intensity of the light beam at a large view angle may be further restrained after the light beam passes through the view angle control structure 100 and the light control film 410 so as to enhance an anti-peeping effect.

Moreover, in the embodiment, the display panel 300 shares the second polarizing layer 112 with the view angle control structure 100 by omitting the polarizing layer 330.

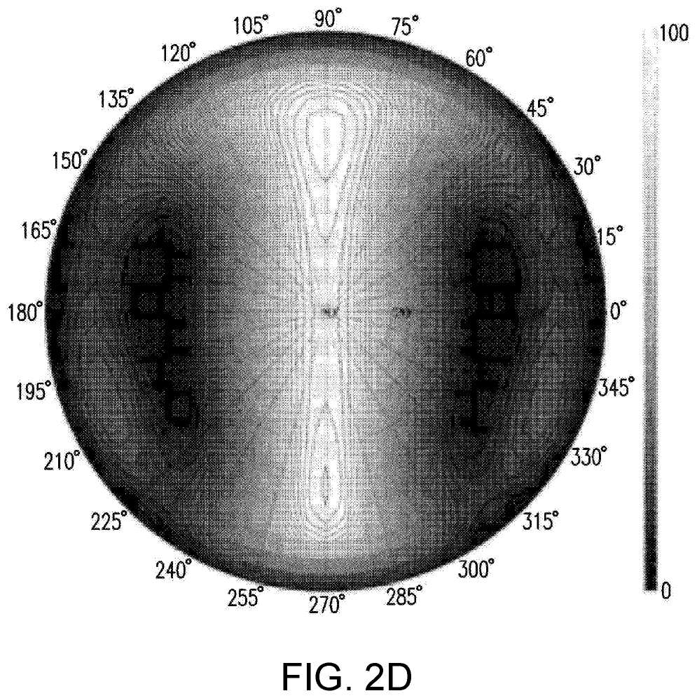

FIG. 5 is a schematic structural diagram of a display apparatus according to another embodiment of the invention. Referring to FIG. 5, a display apparatus 50 includes a light emitting module 200, a view angle control structure 500 and a display panel 300. The light emitting module 200 is configured to provide the illuminating light beam LB. The view angle control structure 500 includes a first view angle control structure 501 and a second view angle control structure 502, the first view angle control structure 501 is disposed between the light emitting module 200 and the display panel 300, and the second view angle control structure 502 is disposed above (the Z direction) the display panel 300. In the embodiment, the display panel 300 includes a third polarizing layer 310 and a liquid crystal display layer 320, but the polarizing layer 330 is omitted.

The view angle control structure 500 of the embodiment further includes a second view angle control structure 502 disposed above the display panel 300 in comparison with the view angle control structure 100 of FIG. 3, and the second view angle control structure 502 includes a fourth polarizing layer 510, a third substrate 520, a fourth substrate 522 and a second polarization adjusting layer 530. Especially, the polarization adjusting layer 130 of the view angle control structure 500 may be referred to as a first polarization adjusting layer herein. The structure details and implementation of the second polarization adjusting layer 530 are similar to those of the polarization adjusting layer 130 of FIG. 1B, and a person skilled in the art may obtain enough teachings and suggestions according to the foregoing descriptions, which are not further described herein.

The third substrate 520, the second polarization adjusting layer 530, the fourth substrate 522 and the fourth polarizing layer 510 are sequentially disposed on the transmission path of the display light beam IB, and the third substrate 520 and the fourth substrate 522 are located between the third polarizing layer 310 and the fourth polarizing layer 510, wherein at least one of the third substrate 520 and the fourth substrate 522 has a birefringence. The second polarization adjusting layer 530 is disposed on the transmission path of the display light beam IB and located between the third substrate 520 and the fourth substrate 522.

It should be particularly noted that, in the embodiment of FIG. 5, optical phase differences of liquid crystal layers in the polarization adjusting layer 130 and the second polarization adjusting layer 530 may be the same or different. A voltage applied to the polarization adjusting layer 130 is referred to as a first applied voltage, and a voltage applied to the second polarization adjusting layer 530 is referred to as a second applied voltage, wherein the first applied voltage may be the same as or different from the second applied voltage. The polarization adjusting layer 130 changes the polarization state of the illuminating light beam LB according to the first applied voltage, and the second polarization adjusting layer 530 changes the polarization state of the display light beam IB according to the second applied voltage.

In short, in the embodiment of FIG. 5, the view angle range of the display apparatus 50 is adjusted more flexibly by using two polarization adjusting layers.

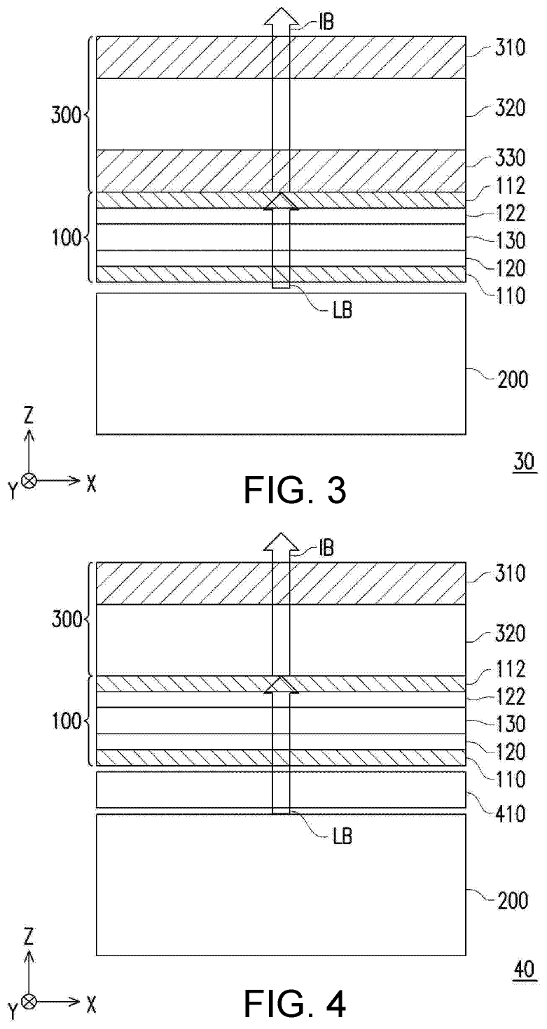

FIG. 6 is a schematic structural diagram of a display apparatus according to another embodiment of the invention. Referring to FIG. 6, a display apparatus 60 includes a light emitting module 200, a view angle control structure 600 and a display panel 602. The view angle control structure 600 is disposed on the display panel 602. The structure details and implementation of the view angle control structure 600 are similar to those of the view angle control structure 100 of FIG. 1B, and it should be noted that, the first polarizing layer 610 of the view angle control structure 600 is particularly a reflective polarizer. The light beam B in FIG. 1B is a display light beam IB here. Therefore, the polarization adjusting layer 130 can change the polarization state of the display light beam IB according to the applied voltage.

In the embodiment, the display panel 602 is a liquid crystal display panel, but is not limited thereto. In other embodiments, the display panel 602 may be a self-luminous display panel, for example, a light emitting diode (LED) display panel, an organic light emitting diode (OLED), or other types of display technologies. In the embodiment, the light emitting module 200 may be omitted.

The display panel 602 at least includes a third polarizing layer 620 and a liquid crystal display layer 630. The liquid crystal display layer 630 is located between the third polarizing layer 620 and the first polarizing layer 610. The display panel 602 further includes a polarizing layer 640 disposed between the first polarizing layer 610 and the liquid crystal display layer 630. However, in other embodiments, the polarizing layer 640 may be omitted for the display panel 602.

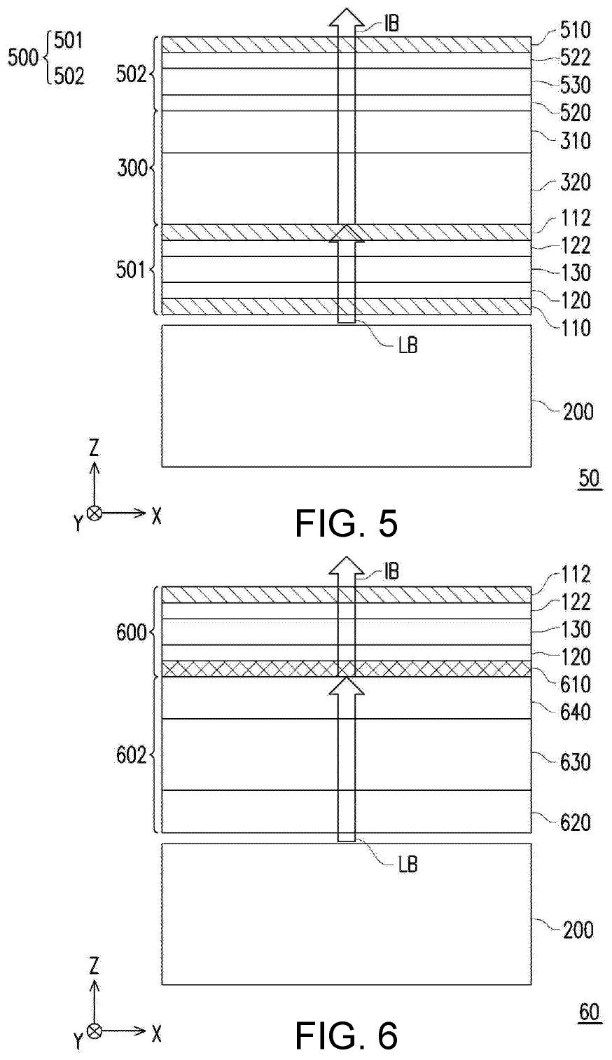

FIG. 7 is a schematic structural diagram of a display apparatus according to another embodiment of the invention. Referring to FIG. 7, a display apparatus 70 includes a light emitting module 200, a view angle control structure 700 and a display panel 602, wherein the view angle control structure 700 is disposed above the display panel 602. The display apparatus 70 is similar to the display apparatus 60, but the view angle control structure 700 further includes a fourth polarizing layer 710, a third substrate 720, a fourth substrate 722 and a second polarization adjusting layer 730 in comparison with the view angle control structure 600 of FIG. 6. For clarity of description, the polarization adjusting layer 130 in FIG. 7 may be referred to as a first polarization adjusting layer. The structure and implementation of the second polarization adjusting layer 730 are similar to those of the polarization adjusting layer 130, and are not further described herein.

The third substrate 720 and the fourth substrate 722 are sequentially disposed on the transmission path of the display light beam IB and are located between the first polarizing layer 610 and the fourth polarizing layer 710, wherein at least one of the third substrate 720 and the fourth substrate 722 has a birefringence.

In the embodiment, optical phase differences of the liquid crystal layers in the polarization adjusting layer 130 and the second polarization adjusting layer 730 may be the same or different. A voltage applied to the polarization adjusting layer 130 is referred to as a first applied voltage, and a voltage applied to the second polarization adjusting layer 730 is referred to as a second applied voltage, wherein the first applied voltage may be the same as or different from the second applied voltage. Therefore, the polarization adjusting layer 130 and the second polarization adjusting layer 730 in FIG. 7 change the polarization state of the display light beam IB respectively according to the first applied voltage and the second applied voltage.

In another embodiment, if necessary, the view angle control structure 700 may further include a polarizing layer disposed between the third substrate 720 and the first polarizing layer 610, which is not limited in the invention. In another embodiment, the first polarizing layer 610 in FIG. 7 may also be a reflective polarizer. In another embodiment, the polarizing layer 640 may be omitted for the display panel 602 of FIG. 7.

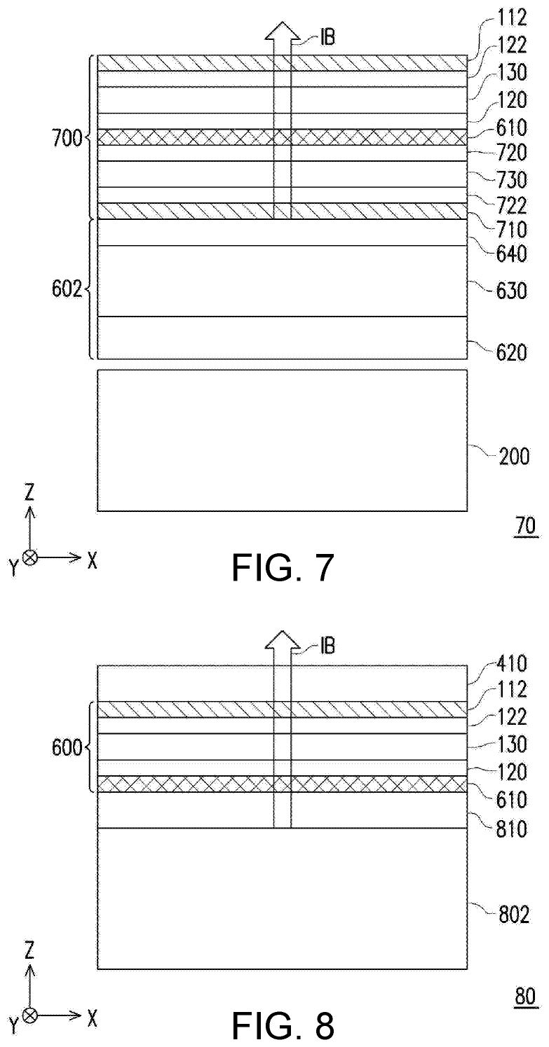

FIG. 8 is a schematic structural diagram of a display apparatus according to another embodiment of the invention. Referring to FIG. 8, a display apparatus 80 includes a light emitting and display module 802, a view angle control structure 600 and a phase retarder 810. The light emitting and display module 802, for example, includes an LCD display panel and a backlight unit, an LED display panel or an OLED display panel. The view angle control structure 600 is disposed on the light emitting and display module 802 to adjust the light emitting view angle range of the display light beam IB. Reference can be made to the embodiment of FIG. 6 for a specific implementation. In the embodiment, the first polarizing layer 610 is a reflective polarizer.

The phase retarder 810 is disposed on the transmission path of the display light beam IB, and located between the view angle control structure 600 and the light emitting and display module 802. The phase retarder 810 is capable of adjusting a phase of the display light beam IB after leaving the light emitting and display module 802 so as to be suitable for entering the first polarizing layer 610. The phase retarder 810, for example, is a ½ wave plate.

In another embodiment, an OLED display panel is used as the light emitting and display module 802, and the display apparatus 80 further includes a light control film 410. Compared with an LCD display panel, the display light beam IB coming from the OLED display panel has a wider view angle range, and therefore, the light control film 410 may be disposed above the view angle control structure 600 to enhance the anti-peeping effect. The display light beam IB passes through the view angle control structure 600 and then passes through the light control film 410.

In yet another embodiment, the view angle control structure 600 and the light control film 410 of the display apparatus 80 may be replaced by the view angle control structure 700 of FIG. 7. A person skilled in the art may select a proper view angle control structure according to actual requirements, which is not limited in the invention.

Moreover, for related implementations and configuration relationship of the display apparatus 80 of FIG. 8, sufficient teachings, suggestions and implementation descriptions can be obtained from the foregoing embodiments and implementations, and the details will not be described herein again.

To sum up, an exemplary embodiment of the invention provides a view angle control structure and a display apparatus. The display apparatus includes the view angle control structure. A polarization adjusting layer of the view angle control structure is located between a first substrate and a second substrate, and configured to change a polarization state of a light beam according to an applied voltage. At least one of the first substrate and the second substrate has a birefringence. Therefore, the view angle control structure and the display apparatus of the embodiments of the invention can actively switch between a normal mode and an anti-peeping mode and have an advantage of being light and thin in structure. Moreover, due to the characteristic of birefringence of the first substrate or/and the second substrate, the view angle control structure can provide a sufficient phase change. Therefore, the display apparatus may omit a compensation film, and has advantages of reducing the cost and simplifying the structure. In some embodiments of the invention, the first substrate and the second substrate may be made from a flexible material. As a result, the embodiments of the invention can provide a light and thin flexible display apparatus with an active anti-peeping function.

The foregoing description of the preferred embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like does not necessarily limit the claim scope to a specific embodiment, and the reference to particularly preferred exemplary embodiments of the invention does not imply a limitation on the invention, and no such limitation is to be inferred. The invention is limited only by the spirit and scope of the appended claims. Moreover, these claims may use “first”, “second”, etc. followed with noun or element. Such terms should be understood as a nomenclature and should not be construed as giving the limitation on the number of the elements modified by such nomenclature unless specific number has been given. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the invention as defined by the following claims. Moreover, no element and component in the disclosure is intended to be dedicated to the public regardless of whether the element or component is explicitly recited in the following claims.

What is claimed is:

1. A view angle control structure, the view angle control structure comprising a first polarizing layer, a second polarizing layer, a first substrate, a second substrate and a polarization adjusting layer, wherein:
the first polarizing layer and the second polarizing layer are sequentially disposed on a transmission path of a light beam;
the first substrate and the second substrate are sequentially disposed on the transmission path of the light beam and are located between the first polarizing layer and the second polarizing layer, wherein at least one of the first substrate and the second substrate has a birefringence; and
the polarization adjusting layer is disposed on the transmission path of the light beam and located between the first substrate and the second substrate and is configured to change a polarization state of the light beam according to an applied voltage.

2. The view angle control structure according to claim 1, wherein the polarization adjusting layer comprises:
a liquid crystal layer;
a first electrode and a second electrode, respectively disposed at two opposite sides of the liquid crystal layer and configured to provide the applied voltage to the liquid crystal layer; and
a first alignment layer and a second alignment layer, the first alignment layer being located between the first electrode and the liquid crystal layer, the second alignment layer being located between the liquid crystal layer and the second electrode, an included angle between alignment directions of the first alignment layer and the second alignment layer falling within a range of 165 degrees to 195 degrees.

3. The view angle control structure according to claim 2, wherein an included angle between the alignment direction of the first alignment layer and a direction of an absorption axis of the first polarizing layer falls within a range of −15 degrees to 15 degrees or a range of 75 degrees to 105 degrees.

4. The view angle control structure according to claim 2, wherein an optical phase difference of the liquid crystal layer falls within a range of 600 nanometers to 1000 nanometers.

5. The view angle control structure according to claim 1, wherein a sum of out-of-plane retardations of the first substrate and the second substrate falls within a range of 200 nanometers to 800 nanometers.

6. The view angle control structure according to claim 1, wherein in-plane retardations of the first substrate and the second substrate are less than or equal to 150 nanometers.

7. The view angle control structure according to claim 1, wherein the first substrate or the second substrate is made from a flexible material.

8. A display apparatus, the display apparatus comprising a light emitting module, a view angle control structure and a display panel, wherein:
the light emitting module is configured to provide an illuminating light beam;
the view angle control structure is disposed on the light emitting module, and comprises a first polarizing layer, a second polarizing layer, a first substrate, a second substrate and a polarization adjusting layer, wherein:
the first polarizing layer and the second polarizing layer are sequentially disposed on a transmission path of the illuminating light beam;
the first substrate and the second substrate are sequentially disposed on the transmission path of the illuminating light beam and are located between the first polarizing layer and the second polarizing layer, wherein at least one of the first substrate and the second substrate has a birefringence; and
the polarization adjusting layer is disposed on the transmission path of the illuminating light beam and located between the first substrate and the second substrate; and
the display panel is disposed on the view angle control structure and is configured to convert the illuminating light beam coming from the view angle control structure into a display light beam,
wherein the first polarization adjusting layer changes a polarization state of the illuminating light beam according to a first applied voltage.

9. The display apparatus according to claim 8, wherein the display panel comprises:
a third polarizing layer, disposed on a transmission path of the display light beam; and
a liquid crystal display layer, disposed between the second polarizing layer and the third polarizing layer.

10. The display apparatus according to claim 9, wherein the view angle control structure further comprises:
a fourth polarizing layer, disposed on the transmission path of the display light beam;
a third substrate and a fourth substrate, sequentially disposed on the transmission path of the display light beam and located between the third polarizing layer and the fourth polarizing layer, wherein at least one of the third substrate and the fourth substrate has a birefringence; and
a second polarization adjusting layer, disposed on the transmission path of the display light beam and located between the third substrate and the fourth substrate,
wherein the second polarization adjusting layer changes a polarization state of the display light beam according to a second applied voltage.

11. The display apparatus according to claim 8, wherein the display apparatus further comprises:
a light control film, disposed on the transmission path of the illuminating light beam or a transmission path of the display light beam.

12. A display apparatus, the display apparatus comprising a display panel and a view angle control structure, wherein:
the display panel is configured to provide a display light beam; and
the view angle control structure is disposed on the display panel, and comprises a first polarizing layer, a second polarizing layer, a first substrate, a second substrate and a polarization adjusting layer, wherein:
the first polarizing layer and the second polarizing layer are sequentially disposed on a transmission path of the display light beam;
the first substrate and the second substrate are sequentially disposed on the transmission path of the display light beam and are located between the first polarizing layer and the second polarizing layer, wherein at least one of the first substrate and the second substrate has a birefringence; and
the first polarization adjusting layer is disposed on the transmission path of the display light beam and located between the first substrate and the second substrate,
wherein the first polarization adjusting layer changes a polarization state of the display light beam according to a first applied voltage.

13. The display apparatus according to claim 12, wherein the display panel is a self-luminous display panel.

14. The display apparatus according to claim 12, wherein the display panel comprises:
a third polarizing layer; and
a liquid crystal display layer, located between the third polarizing layer and the first polarizing layer.

15. The display apparatus according to claim 12, wherein the first polarizing layer comprises a reflective polarizer.

16. The display apparatus according to claim 12, wherein the view angle control structure further comprises:
a fourth polarizing layer, disposed on the transmission path of the display light beam;
a third substrate and a fourth substrate, sequentially disposed on the transmission path of the display light beam and located between the first polarizing layer and the fourth polarizing layer, wherein at least one of the third substrate and the fourth substrate has a birefringence; and
a second polarization adjusting layer, disposed on the transmission path of the display light beam and located between the third substrate and the fourth substrate,
wherein the second polarization adjusting layer changes the polarization state of the display light beam according to a second applied voltage.

17. The display apparatus according to claim 16, wherein the first polarizing layer comprises a reflective polarizer.
